(19) United States
(12) Patent Application Publication
(10) Pub. No.: US 2026/0192549 A1
(43) Pub. Date: Jul. 9, 2026

(54) LAMINATED GLASS AND LAMINATED GLASS FOR VEHICLE

(71) Applicant: AGC Inc., Tokyo (JP)

(72) Inventors: Hideyuki HIRAKOSO, Tokyo (JP); Hisao INOKUMA, Chiyoda-ku (JP); Yasushi KAWAMOTO, Tokyo (JP); Yukihiro SUMI, Tokyo (JP)

(73) Assignee: AGC Inc., Tokyo (JP)

(21) Appl. No.: 19/554,524

(22) Filed: Mar. 2, 2026

Related U.S. Application Data
(63) Continuation of application No. PCT/JP2024/031521, filed on Sep. 3, 2024.

(30) Foreign Application Priority Data
Sep. 7, 2023 (JP) 2023-145226

(51) Int. Cl. B32B 17/10

(52) U.S. Cl. CPC B32B 17/10045; B32B 17/10651; B32B 2250/03; B32B 2307/202; B32B 2307/4026; B32B 2307/416; B32B 2307/7376; B32B 2551/00; B32B 2605/08

(57) ABSTRACT

A laminated glass capable of, even when light is shielded, reducing the reflection of the interior of a cabin or the like is provided. A laminated glass comprises a first glass plate, a first intermediate film, a PDLC-type light control film, a second intermediate film, and a second glass plate in this order, in which the laminated glass has a total light transmittance of 10% or less and a haze value of 50% or more when the PDLC-type light control film is turned off, the second glass plate includes a low-emissivity film on a surface thereof opposite to a side of the second intermediate film, and a visible light reflectance of a surface of the low-emissivity film opposite to a side of the second glass plate is 0.2% or more and 3.8% or less.

### INCORPORATION BY REFERENCE

This application is based upon and claims the benefit of priority from Japanese patent application No. 2023-145226, filed on Sep. 7, 2023, and PCT application No. PCT/JP2024/031521 filed on Sep. 3, 2024, the disclosure of which is incorporated herein in its entirety by reference.

### BACKGROUND

The present invention relates to a laminated glass, a laminated glass for vehicle, and a laminated glass for vehicle roof.

It is known that when a low-emissivity film is formed on a window glass of a vehicle, a building, a ship, etc., heat transfer through the window glass is reduced. By reducing heat transfer through the window glass, the comfort of passengers and residents inside the vehicle, the building, the ship, etc., can be improved. A laminated glass including a low-emissivity film formed on the indoor-side surface thereof reduces reradiation of heat from outside the cabin such as sunlight, and reduces outflow of heat generated from people inside the cabin etc. to the outside, thereby reducing heat transfer between the outside and the inside of the cabin through the glass.

Published Japanese Translation of PCT International Publication for Patent Application, No. 2015-512854 discloses a technique for forming a low-emissivity film on the indoor-side surface of a substrate.

### SUMMARY

In recent years, a technique for using a laminated glass having a light control function as a window glass of a building or a vehicle has been developed. A laminated glass having such a light control function can be configured by providing a light control film on the laminated glass. For example, a PDLC-type light control film may be used as a light control film for the laminated glass. By forming a low-emissivity film on the indoor-side surface of the glass in the above laminated glass, the comfort inside a cabin can be improved and privacy can be secured.

However, in the laminated glass on which a low-emissivity film is formed, when light from the outside of the cabin is shielded by a light control film, the amount of light from the outside of the cabin decreases. Therefore, there is a problem that the reflection of the interior of the cabin or the like on the laminated glass becomes prominent.

Further, when a PDLC-type light control film is used as a light control film for the laminated glass, the laminated glass may have a grainy appearance when viewed from the indoor side due to the working principle of the PDLC-type light control film. When the grainy appearance becomes pronounced, a specific discomfort (haze discomfort) may be generated.

In view of the above-described problem, an object of the present invention is to provide a laminated glass, a laminated glass for vehicle, and a laminated glass for a vehicle roof which are capable of, even when light is shielded, reducing the reflection of the interior of a cabin or the like and reducing haze discomfort.

A glass plate for vehicle, a laminated glass for a vehicle, and a laminated glass for vehicle roof according to one aspect of the present disclosure have the following configurations.

[1]

A laminated glass comprising a first glass plate, a first intermediate film, a PDLC-type light control film, a second intermediate film, and a second glass plate in this order, wherein
the laminated glass has a total light transmittance of 10% or less and a haze value of 50% or more when the PDLC-type light control film is turned off,
the second glass plate includes a low-emissivity film on a surface thereof opposite to a side of the second intermediate film, and
a visible light reflectance of a surface of the low-emissivity film opposite to a side of the second glass plate is 0.2% or more and 3.8% or less.
   [2]

The laminated glass according to [1], wherein
the low-emissivity film includes a transparent conductive layer and a reflection adjustment layer in this order from the side of the second glass plate, and
a ratio of a film thickness of the reflection adjustment layer to a film thickness of the transparent conductive layer is 0.47 or more and 0.70 or less.
   [3]

A laminated glass comprising a first glass plate, a first intermediate film, a PDLC-type light control film, a second intermediate film, and a second glass plate in this order, wherein
the laminated glass has a total light transmittance of 10% or less and a haze value of 50% or more when the PDLC-type light control film is turned off,
the second glass plate includes a low-emissivity film on a surface thereof opposite to a side of the second intermediate film,
the low-emissivity film includes a transparent conductive layer and a reflection adjustment layer in this order from the side of the second glass plate, and
a ratio of a film thickness of the reflection adjustment layer to a film thickness of the transparent conductive layer is 0.47 or more and 0.70 or less.
   [4]

The laminated glass according to [3], wherein a visible light reflectance of a surface of the low-emissivity film opposite to the side of the second glass plate is 0.2% or more and 3.8% or less.

[5]

The laminated glass according to any one of [2] to [4], wherein a film thickness of the transparent conductive layer is 80 nm or more and 160 nm or less.

[6]

The laminated glass according to any one of [2] to [5], wherein the transparent conductive layer is an ITO layer, a tin oxide layer, a fluorine-doped tin oxide layer, an antimony-doped tin oxide layer, a silver layer, a zirconium nitride layer, or a titanium nitride layer.

[7]

The laminated glass according to any one of [2] to [6], wherein the reflection adjustment layer includes an oxide or an oxynitride of at least one metal selected from a group consisting of Ti, Nb, Ta, Zn, Al, In, Si, and Zr.

[8]

The laminated glass according to any one of [2] to [7], wherein a film thickness of the reflection adjustment layer is 50 nm or more and 100 nm or less.

[9]

The laminated glass according to any one of [2] to [8], wherein
the low-emissivity film further includes a color tone correction layer,
the color tone correction layer includes a plurality of layers including a first layer and a second layer in this order from the side of the second glass plate, and
a refractive index of the first layer for light having a wavelength of 630 nm is higher than a refractive index of the second layer for light having a wavelength of 630 nm.
   [10]

The laminated glass according to [9], wherein
the refractive index of the first layer for light having a wavelength of 630 nm is 1.7 or more and 2.5 or less, and
the refractive index of the second layer for light having a wavelength of 630 nm is 1.6 or less.
   [11]

The laminated glass according to any one of [2] to [10], wherein
the low-emissivity film further includes a color tone correction layer, and
the color tone correction layer includes an oxide or an oxynitride of at least one metal selected from a group consisting of Ti, Nb, Ta, Zn, Al, In, Si, and Zr.
   [12]

The laminated glass according to any one of [2] to [11], wherein
the low-emissivity film includes a color tone correction layer between a surface of the second glass plate on a side of the low-emissivity film and the transparent conductive layer, and
a film thickness of the color tone correction layer is 20 nm or more and 60 nm or less.
   [13]

The laminated glass according to any one of [1] to [12], wherein an emissivity of the surface of the low-emissivity film opposite to the side of the second glass plate is 0.3 or less.

[14]

The laminated glass according to any one of [2] to [13], wherein the low-emissivity film includes an adhesion improvement layer disposed between the transparent conductive layer and the reflection adjustment layer.

[15]

A laminated glass for a vehicle, the laminated glass comprising the laminated glass according to any one of [1] to [14].

[16]

A laminated glass for a vehicle roof, the laminated glass comprising the laminated glass according to any one of [1] to [14].

According to the present invention, it is possible to provide a laminated glass, a laminated glass for vehicle, and a laminated glass for vehicle roof which are capable of, even when light is shielded, reducing the reflection of the interior of a cabin or the like and reducing haze discomfort.

The above and other objects, features and advantages of the present disclosure will become more fully understood from the detailed description given hereinbelow and the accompanying drawings.

### BRIEF DESCRIPTION OF THE DRAWINGS

FIG. 1 is a cross-sectional view showing an example of a configuration of a laminated glass according to an embodiment;

FIG. 2 is a cross-sectional view showing an example of a low-emissivity film provided in the laminated glass according to the embodiment;

FIG. 3 is a cross-sectional view showing a modified example of the low-emissivity film provided in the laminated glass according to the embodiment; and

FIG. 4 is a cross-sectional view showing a modified example of the low-emissivity film provided in the laminated glass according to the embodiment.

### DESCRIPTION OF EMBODIMENTS

Embodiments of the present invention will be described hereinafter with reference to the drawings.

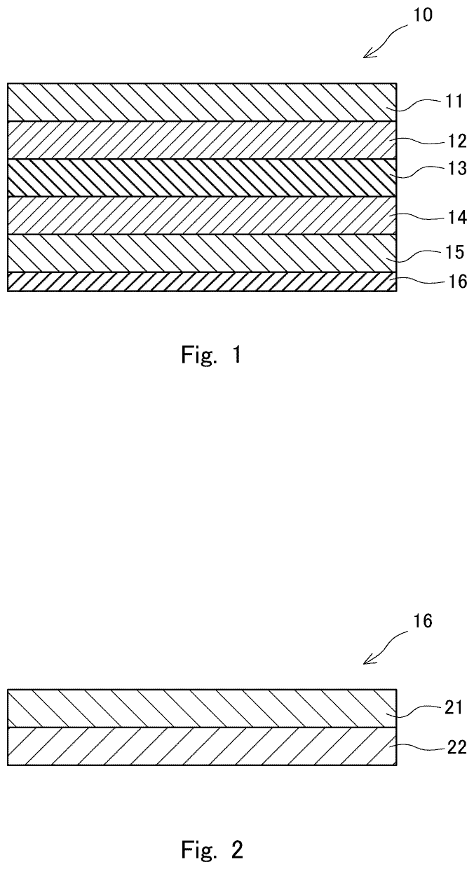

FIG. 1 is a cross-sectional view showing an example of a configuration of a laminated glass according to this embodiment. As shown in FIG. 1, a laminated glass 10 according to this embodiment includes a first glass plate 11, a first intermediate film 12, a PDLC-type light control film 13, a second intermediate film 14, a second glass plate 15, and a low-emissivity film 16 in this order.

The laminated glass 10 according to this embodiment is applied to a window glass of, for example, a vehicle, a building, a ship, etc. The laminated glass 10 is suitably used for a laminated glass for vehicle. The laminated glass 10 is particularly suitably used for a laminated glass for vehicle roof or the like in view of excellent heat shielding. The laminated glass for vehicle roof is used for vehicle roofs. The laminated glass 10 is mounted so that the surface thereof on the side of the first glass plate 11 faces the outside of the vehicle or the outside of the cabin, and the surface thereof on the side of the low-emissivity film 16 faces the inside of the vehicle or the inside of the cabin. In the following description, “the outside of the vehicle (outside the vehicle) or the outside of the cabin (outside the cabin)” may be simply referred to as “the outside of the cabin (outside the cabin)”. Further, “the inside of the vehicle (inside the vehicle) or the inside of the cabin (inside the cabin)” may be simply referred to as “the inside of the cabin (inside the cabin)”.

The PDLC-type light control film 13 is a light control film using a polymer-dispersed liquid crystal (PDLC). The PDLC-type light control film 13 has a light control function in which a transmission index changes in accordance with an applied voltage. By adjusting the applied voltage of the PDLC-type light control film 13, transmission of visible light and near-infrared rays through the laminated glass 10 can be reversibly controlled. By reducing the transmittance of visible light and near-infrared rays through the laminated glass 10, heat rays from the outside of the cabin to the inside thereof can be shielded, and hence a rise in temperature in the cabin can be reduced. Further, by reducing the transmittance of visible light through the laminated glass 10, visible light from the inside of the cabin to the outside thereof can be shielded, and hence the state of the inside of the cabin can be hardly seen from the outside of the cabin. Therefore, the laminated glass 10 can adjust the environment inside the cabin and ensure privacy.

When the PDLC-type light control film 13 is turned off, the laminated glass 10 according to this embodiment has a total light transmittance of 10% or less and a haze value of 50% or more. Note that “turning off the PDLC-type light control film 13” means minimizing a parallel light transmittance of the laminated glass 10 by adjusting an applied voltage of the PDLC-type light control film 13. In other words, “turning off the PDLC-type light control film 13” means shielding light transmitted through the laminated glass 10. When the PDLC-type light control film 13 is turned off, a haze value of the laminated glass 10 becomes maximum.

The total light transmittance of the laminated glass 10 when the PDLC-type light control film 13 is turned off is preferably low, that is, preferably closer to 0%. The total light transmittance of the laminated glass 10 when the PDLC-type light control film 13 is turned off is preferably 10% or less, more preferably 8% or less, still more preferably 6% or less, even more preferably 5% or less, particularly preferably 3% or less, particularly more preferably 2% or less, extremely preferably 1% or less, more extremely preferably 0.5% or less, still more extremely preferably 0.3% or less, particularly extremely preferably 0.1% or less, and particularly more extremely preferably 0.05% or less, in order to adjust the environment inside the cabin and ensure privacy. In a case where it is desired that the view outside a vehicle can be seen from inside the vehicle, the total light transmittance of the laminated glass 10 when the PDLC-type light control film 13 is turned off may be 0.01% or more. The haze value of the laminated glass 10 when the PDLC-type light control film 13 is turned off is preferably 50% or more, more preferably 60% or more, still more preferably 70% or more, particularly preferably 80% or more, particularly more preferably 85% or more, extremely preferably 90% or more, and particularly extremely preferably 95% or more, in order to secure privacy. Note that the total light transmittance is a value measured by a spectrophotometer. The haze value is a value measured by a haze meter. The total light transmittance and the haze value of the laminated glass 10 may be measured in a laboratory, or may be measured in a state in which the laminated glass 10 is mounted on a vehicle or the like.

The types of the first glass plate 11 and the second glass plate 15 are not limited to particular types. The first glass plate 11 and the second glass plate 15 may be made of, for example, soda lime glass, quartz glass, borosilicate glass, or alkaline-free glass. The first glass plate 11 and the second glass plate 15 are preferably made of soda lime glass in view of bendability.

The first glass plate 11 and the second glass plate 15 may be colorless or colored. The plate thickness of each of the first glass plate 11 and the second glass plate 15 is preferably 0.5 mm or more, more preferably 0.8 mm or more, still more preferably 1.0 mm or more, particularly preferably 1.3 mm or more, and particularly more preferably 1.6 mm or more. The plate thickness of each of the first glass plate 11 and the second glass plate 15 is preferably 5.0 mm or less, more preferably 4.5 mm or less, still more preferably 4.0 mm or less, particularly preferably 3.5 mm or less, and particularly more preferably 3.2 mm or less. The plate thicknesses of the first glass plate 11 and the second glass plate 15 may be the same as or different from each other. Further, each of the first glass plate 11 and the second glass plate 15 may be an ultraviolet protection glass plate by which ultraviolet rays can be shielded. The ultraviolet protection glass plate is a glass plate in which the transmittance of ultraviolet rays is reduced, and may be, for example, a borosilicate glass containing a copper compound. Note that the copper compound is, for example, cuprous oxide.

The first intermediate film 12 and the second intermediate film 14 are preferably made of, for example, transparent resins. Examples of the resins of which the first intermediate film 12 and the second intermediate film 14 are made include polyvinyl butyral (PVB), polyvinyl chloride, ethylene vinyl acetate (EVA), cycloolefin polymer, urethane resin, and polyvinylidene fluoride resin (PVDF). The film thickness of each of the first intermediate film 12 and the second intermediate film 14 is preferably 0.1 mm or more, more preferably 0.2 mm or more, and still more preferably 0.3 mm or more. The film thickness of each of the first intermediate film 12 and the second intermediate film 14 is preferably 2.0 mm or less, more preferably 1.0 mm or less, and still more preferably 0.7 mm or less. Further, the first intermediate film 12 and the second intermediate film 14 may be colorless or colored. The first intermediate film 12 and the second intermediate film 14 may be colored, for example, by being made using a resin including colorants such as pigments.

The visible light reflectance of the surface (the indoor-side surface) of the low-emissivity film 16 opposite to the side of the second glass plate 15 is 3.8% or less. Therefore, even when the PDLC-type light control film 13 is turned off, that is, even when the amount of light transmitted from the side of the first glass plate 11 is small, the absolute amount of reflected light of the visible light is reduced in the laminated glass 10. Therefore, when the side of the first glass plate 11 is viewed from the side of the low-emissivity film 16, the reflection of the interior of the cabin or the like on the laminated glass 10 can be reduced. In other words, when the laminated glass 10 is viewed from the indoor side, the reflection of the interior of the cabin or the like on the laminated glass 10 can be reduced. The visible light reflectance of the indoor-side surface of the low-emissivity film 16 is preferably 3.6% or less, more preferably 3.5% or less, still more preferably 3.3% or less, particularly preferably 3.0% or less, particularly more preferably 2.8% or less, extremely preferably 2.5% or less, more extremely preferably 2.3% or less, still more extremely preferably 2.0% or less, particularly extremely preferably 1.8% or less, and particularly more extremely preferably 1.5% or less, in order to sufficiently reduce the reflection of the interior of the cabin or the like. Further, the visible light reflectance of the indoor-side surface of the low-emissivity film 16 is preferably 0.2% or more, more preferably 0.5% or more, still more preferably 0.8% or more, and particularly preferably 1.0% or more, in order to reduce haze discomfort. Note that the visible light reflectance is a value measured by a measurement method in conformity with JIS R3106.

The laminated glass 10 may have a grainy appearance when viewed from the low-emissivity film surface due to the working principle of the PDLC-type light control film 13. When the grainy appearance becomes pronounced, a person in the cabin may feel discomfort. In the following description, discomfort caused by a pronounced grainy appearance is referred to as “haze discomfort”. The visible light reflectance of the surface of the low-emissivity film 16 opposite to the side of the second glass plate 15 is preferably 0.2% or more, and more preferably 1.0% or more, in order to reduce haze discomfort.

The laminated glass 10 may contain heat due to light from outside such as sunlight. The low-emissivity film 16 reduces reradiation of heat contained in the laminated glass 10 to the inside of the cabin, thereby reducing a rise in temperature in the cabin in summer or the like. Further, the low-emissivity film 16 reduces heat diffusion from the inside to the outside of the cabin, thereby suppressing a decrease in temperature of the cabin in winter or the like. As described above, the low-emissivity film 16 has an environment adjusting function for adjusting the environment of a cabin. The emissivity of the surface of the low-emissivity film 16 opposite to the side of the second glass plate 15 is preferably 0.3 or less in order to sufficiently perform the environment adjusting function. Note that the emissivity is a value measured by a measurement method in conformity with JIS R1801.

The low-emissivity film 16 may include, for example, a transparent conductive layer 21, a reflection adjustment layer 22, and other layers. In this embodiment, a description will be given of a case where the low-emissivity film 16 includes the transparent conductive layer 21 and the reflection adjustment layer 22. FIG. 2 is a cross-sectional view showing an example of the low-emissivity film included in the laminated glass 10 according to the first embodiment. The low-emissivity film 16 of the laminated glass 10 according to this embodiment includes the transparent conductive layer 21 and the reflection adjustment layer 22 in this order from the side of the second glass plate 15.

The transparent conductive layer 21 is preferably an indium tin oxide (ITO) layer, a tin oxide layer, a fluorine-doped tin oxide layer, an antimony-doped tin oxide layer, a silver layer, a zirconium nitride layer, or a titanium nitride layer. The transparent conductive layer 21 may contain an additive. When the transparent conductive layer 21 is an ITO layer, the additive may be, for example, Ga, Zn, Al, and/or Nb. When the transparent conductive layer 21 is an ITO layer, the ratio of tin oxide contained in the ITO layer is preferably 5 mass % or more and 12.5 mass % or less, and more preferably 6.5 mass % or more and 11 mass % or less, in order to reduce resistance. Further, the ITO layer may contain, in addition to ITO, less than 50 mass % of another material. The other material contained in the ITO layer may be, for example, sodium, lead, and/or iron.

The film thickness of the transparent conductive layer 21 is preferably 80 nm or more, more preferably 85 nm or more, particularly preferably 90 nm or more, particularly more preferably 95 nm or more, and extremely preferably 100 nm or more, in order to exhibit sufficient low-emissivity performance and obtain required heat insulation properties. The film thickness of the transparent conductive layer 21 is preferably 160 nm or less, more preferably 155 nm or less, and particularly preferably 150 nm or less, in order to improve productivity. The refractive index of the transparent conductive layer 21 for light having a wavelength of 630 nm is preferably 1.7 or more and 1.8 or less.

The reflection adjustment layer 22 preferably includes an oxide or an oxynitride of at least one metal selected from a group consisting of Ti, Nb, Ta, Zn, Al, In, Si, and Zr, and more preferably includes an oxide of Si. The film thickness of the reflection adjustment layer 22 is preferably 50 nm or more and 100 nm or less in order to reduce the reflectance of light in the visible light region. The film thickness of the reflection adjustment layer 22 is more preferably 55 nm or more, and particularly preferably 60 nm or more. The film thickness of the reflection adjustment layer 22 is more preferably 95 nm or less, particularly preferably 90 nm or less, particularly more preferably 85 nm or less, and extremely preferably 80 nm or less. The refractive index of the reflection adjustment layer 22 for light having a wavelength of 630 nm is preferably 1.7 or less, and more preferably 1.55 or less, in order to exhibit sufficient low-emissivity performance.

The film thickness of the transparent conductive layer 21 relative to the film thickness of the reflection adjustment layer 22 is preferably 0.47 or more and 0.70 or less in order to reduce the reflectance and the emissivity of light in the visible light region. The ratio of the film thickness of the transparent conductive layer 21 to the film thickness of the reflection adjustment layer 22 is more preferably 0.48 or more, particularly preferably 0.49 or more, and particularly more preferably 0.50 or more. The ratio of the film thickness of the transparent conductive layer 21 to the film thickness of the reflection adjustment layer 22 is more preferably 0.68 or less, particularly preferably 0.65 or less, particularly more preferably 0.63 or less, and extremely preferably 0.60 or less.

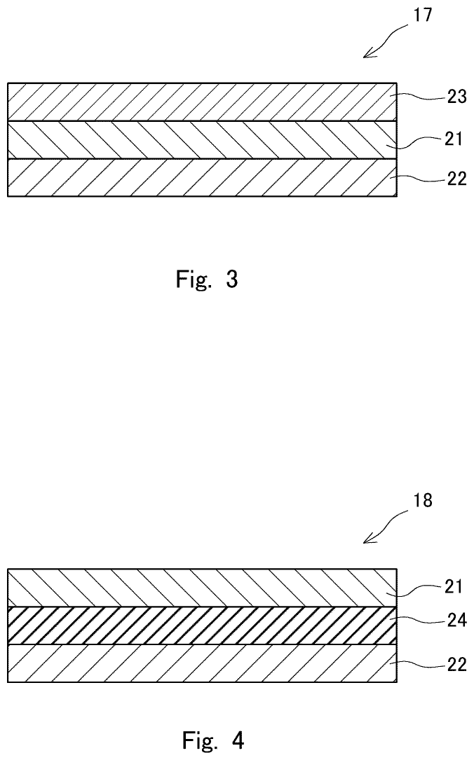

The low-emissivity film 16 shown in FIG. 2 is merely an example, and the low-emissivity film 16 may have another configuration in this embodiment. Modified examples of the low-emissivity film 16 will be described below with reference to FIGS. 3 and 4. Each of FIGS. 3 and 4 is a cross-sectional view showing a modified example of the low-emissivity film provided in the laminated glass according to the embodiment.

A low-emissivity film 17 shown in FIG. 3 further includes a color tone correction layer 23. The color tone correction layer 23 is provided, for example, between the second glass plate 15 and the transparent conductive layer 21. The color tone correction layer 23 may include an oxide or an oxynitride of at least one metal selected from a group consisting of Ti, Nb, Ta, Zn, Al, In, Si, and Zr. The film thickness of the color tone correction layer 23 is preferably 20 nm or more, more preferably 25 nm or more, and particularly preferably 30 nm or more, in order to reduce the angle dependence of the reflected light. The film thickness of the color tone correction layer 23 is preferably 60 nm or less, more preferably 55 nm or less, and particularly preferably 50 nm or less, in order to reduce the angle dependence of the reflected light.

The color tone correction layer 23 may be composed of a plurality of layers including a first layer and a second layer in this order from the side of the second glass plate 15. The refractive index of the first layer for light having a wavelength of 630 nm is higher than the refractive index of the second layer for light having a wavelength of 630 nm. The refractive index of the first layer for light having a wavelength of 630 nm is preferably 1.7 or more and 2.5 or less, more preferably 1.8 or more and 2.3 or less, and particularly preferably 1.8 or more and 2.2 or less. The refractive index of the second layer for light having a wavelength of 630 nm is preferably 1.6 or less, and more preferably 1.55 or less.

The first layer preferably includes an oxide or an oxynitride of at least one metal selected from a group consisting of Ti, Nb, Ta, Zn, Al, In, Si, and Zr. The first layer more preferably contains ZrO₂ doped with 0.1 mass % or more and 10 mass % or less of Si. The film thickness of the first layer is preferably 3 nm or more, more preferably 5 nm or more, particularly preferably 7 nm or more, and particularly more preferably 9 nm or more. The film thickness of the first layer is preferably 40 nm or less, more preferably 35 nm or less, still more preferably 30 nm or less, particularly preferably 25 nm or less, particularly more preferably 23 nm or less, extremely preferably 20 nm or less, more extremely preferably 18 nm or less, still more extremely preferably 17 nm or less, and particularly extremely preferably 15 nm or less.

The second layer is preferably formed using a material which is mainly composed of SiO₂, SiON, or MgF₂, and more preferably formed using a material which is mainly composed of SiO₂. The film thickness of the second layer is preferably 5 nm or more, and more preferably 10 nm or more. The film thickness of the second layer is preferably 50 nm or less, and more preferably 45 nm or less.

A low-emissivity film 18 shown in FIG. 4 further includes an adhesion improvement layer 24. The adhesion improvement layer 24 is provided between the transparent conductive layer 21 and the reflection adjustment layer 22. The adhesion improvement layer 24 is preferably made of metal oxide such as tin oxide, zinc oxide, or cerium oxide. The film thickness of the adhesion improvement layer 24 is preferably 1 nm or more and 10 nm or less.

Note that the laminated glass 10 shown in FIG. 1 is merely an example, and the laminated glass 10 may have another configuration in this embodiment. For example, the laminated glass 10 may be provided with a self-cleaning film on the surface of the first glass plate 11 opposite to the side of the first intermediate film 12. In comparison with dirt adhered to the surface of the glass on which the self-cleaning film is not provided, dirt adhered to the surface of the self-cleaning film is easily removed by contact with moisture such as rain water. The self-cleaning film may be formed by, for example, a titania-based material, a silica-based material, or a siloxane-based material. The film thickness of the self-cleaning film is, for example, 5 nm or more and 50 nm or less, preferably 10 nm or more and 40 nm or less, and more preferably 15 nm or more and 35 nm or less.

Further, the laminated glass 10 may be provided with an infrared ray reflection film between the first glass plate 11 and the PDLC-type light control film 13. The infrared ray reflection film may be provided between the first glass plate 11 and the first intermediate film 12, or may be provided in the first intermediate film 12. By selectively reflecting infrared rays, the infrared ray reflection film reduces a rise in temperature in a cabin, and reduces thermal degradation of the first intermediate film 12, the second intermediate film 14, and the like. The infrared ray reflection film may be composed of a plurality of layers. The infrared ray reflection film may be, for example, configured so that at least one of the plurality of layers includes an infrared ray reflection material. The infrared ray reflection material is a material that reflects infrared rays, and may be, for example, a transparent conductive oxide such as silver (Ag), indium tin oxide, or zinc oxide, fluorine-doped tin oxide, or any other suitable material that shields a considerable amount of infrared rays. The infrared ray reflection film may be, for example, configured to include a layer containing a dielectric (a dielectric layer) and a layer containing Ag (an Ag layer). The dielectric may be, for example, silicon nitride, titanium oxide, silicon oxynitride, tin oxide, another kind of metal (alloy) oxide, or another kind of metal (alloy) nitride. Examples of the other kind of metal oxide include zinc tin oxide, aluminum zinc oxide, nickel chromium oxide, silver oxide, and zinc oxide. The infrared ray reflection film may be, for example, configured so that the Ag layer is sandwiched between at least a pair of the dielectric layers. Further, the infrared ray reflection film may include a plurality of the Ag layers. The infrared ray reflection film preferably includes two or three of the Ag layers in order to exhibit sufficient infrared reflection performance and reduce the manufacturing cost. When the infrared ray reflection film includes two of the Ag layers, the infrared ray reflection film preferably includes a plurality of the dielectric layers, the Ag layer, a plurality of the dielectric layers, the Ag layer, and a plurality of the dielectric layers in this order from the side of the first glass plate 11. When the infrared ray reflection film includes three of the Ag layers, the infrared ray reflection film preferably includes a plurality of the dielectric layers, the Ag layer, a plurality of the dielectric layers, the Ag layer, a plurality of the dielectric layers, the Ag layer, and a plurality of the dielectric layers in this order from the side of the first glass plate 11. The plurality of the dielectric layers are layers including dielectrics different from each other or in which composition ratios of the dielectrics are different from each other. When the infrared ray reflection film includes two of the Ag layers, the film thickness thereof is preferably 500 nm or less, more preferably 400 nm or less, particularly preferably 300 nm or less, and particularly more preferably 250 nm or less. When the infrared ray reflection film includes two of the Ag layers, the film thickness thereof is preferably 50 nm or more, more preferably 100 nm or more, and particularly more preferably 150 nm or more. When the infrared ray reflection film includes three of the Ag layers, the film thickness thereof is preferably 600 nm or less, more preferably 500 nm or less, particularly preferably 400 nm or less, and particularly more preferably 350 nm or less. When the infrared ray reflection film includes three of the Ag layers, the film thickness thereof is preferably 100 nm or more, more preferably 150 nm or more, particularly preferably 200 nm or more, and particularly more preferably 250 nm or more.

### EXAMPLES

Next, examples of the present invention will be described.

Samples of the laminated glass were prepared as samples according to the examples in accordance with the following method. Either of the following glass plates was used.

### <VFL>

Green glass manufactured by AGC Inc.

The plate thickness of VFL was 2.0 mm. The total light transmittance of VFL was 86%.

### <FL>

Clear glass manufactured by AGC Inc.

The plate thickness of FL was 2.0 mm. The total light transmittance of FL was 91%.

### <DGL>

Privacy glass manufactured by AGC Inc.

The plate thickness of DGL was 2.0 mm. The total light transmittance of DGL was 38%.

The first layer of the color tone correction layer was formed on one surface of one glass plate (a second glass plate). In Examples 1 to 21, a ZrO₂ layer containing Si (5 mass % of Si:ZSO) (refractive index in the case of a wavelength of 630 nm=2.12) was formed as the first layer. In Examples 22 to 24, a Ta₂O₅ layer was formed as the first layer. In Examples 25 to 28, a TiO₂ layer was formed as the first layer.

Next, a SiO₂ layer was formed as the second layer of the color tone correction layer on the first layer of the color tone correction layer by a sputtering method.

Next, an ITO layer was formed as the transparent conductive layer on the color tone correction layer by a sputtering method. Note that the second glass plate was not heated during the formation of the film. As a result, an amorphous ITO layer was obtained.

Next, an SiO₂ layer was formed as the reflection adjustment layer on the ITO layer by a sputtering method.

After that, the second glass plate was heated at 650° C. for seven minutes.

Next, the first glass plate, the first intermediate film, the PDLC-type light control film, the second intermediate film, and the second glass plate were laminated in this order to form a laminate. TGCNYO FOGLEAR GREY type (manufactured by Cloudpoint Inc.) was used as the PDLC-type light control film. One of the following films was used as the first intermediate film and the second intermediate film.

### <Clear>

S-LEC™ normal intermediate film manufactured by Sekisui Chemical Co., Ltd.

### <Gray (2%)>

S-LEC™ 7002 manufactured by Sekisui Chemical Co., Ltd.

### <Gray (5%)>

S-LEC™ 7005 manufactured by Sekisui Chemical Co., Ltd.

### <Gray (8%)>

S-LEC™ 7008 manufactured by Sekisui Chemical Co., Ltd.

### <Gray (18%)>

S-LEC™ 7018 manufactured by Sekisui Chemical Co., Ltd.

The laminate was heated to 135° C. and pressurized to obtain samples of the laminated glass according to Examples 1 to 28. Note that Examples 1 to 3 are comparative examples, and Examples 4 to 28 are examples. The combinations of the first and the second glass plates and the first and the second intermediate films used in the samples according to Examples 1 to 28 are shown in Table 1 below.

TABLE 1

| | | First | Second | Second |
|---|---|---|---|---|
| | First | intermediate | intermediate | glass/Low |
| | glass | film | film | radiation film |
| Example 1 | VFL | Gray (2%) | Gray (8%) | DGL |
| Example 2 | VFL | Gray (2%) | Gray (8%) | DGL |
| Example 3 | VFL | Clear | Clear | FL |
| Example 4 | VFL | Gray (2%) | Gray (8%) | FL |
| Example 5 | VFL | Gray (2%) | Gray (8%) | FL |
| Example 6 | VFL | Gray (2%) | Gray (8%) | FL |
| Example 7 | VFL | Gray (2%) | Gray (8%) | FL |
| Example 8 | FL | Gray (18%) | Clear | DGL |
| Example 9 | FL | Gray (18%) | Clear | DGL |
| Example 10 | FL | Gray (18%) | Clear | DGL |
| Example 11 | FL | Gray (18%) | Clear | DGL |
| Example 12 | FL | Gray (5%) | Clear | FL |
| Example 13 | FL | Gray (5%) | Clear | FL |
| Example 14 | FL | Gray (5%) | Clear | FL |
| Example 15 | FL | Gray (5%) | Clear | FL |
| Example 16 | VFL | Clear | Clear | DGL |
| Example 17 | VFL | Clear | Clear | DGL |
| Example 18 | VFL | Clear | Clear | DGL |
| Example 19 | VFL | Clear | Clear | DGL |
| Example 20 | FL | Gray (5%) | Clear | FL |
| Example 21 | VFL | Clear | Clear | DGL |
| Example 22 | VFL | Gray (2%) | Gray (8%) | FL |
| Example 23 | FL | Gray (5%) | Clear | FL |
| Example 24 | FL | Gray (5%) | Clear | FL |
| Example 25 | VFL | Gray (2%) | Gray (8%) | FL |
| Example 26 | FL | Gray (5%) | Clear | FL |
| Example 27 | FL | Gray (5%) | Clear | FL |
| Example 28 | FL | Gray (5%) | Clear | FL |

Further, the film thicknesses of the respective layers of the low-emissivity films provided in the samples according to Examples 1 to 28 are shown in Table 2 below.

TABLE 2

| | | | | | Reflection |
|---|---|---|---|---|---|
| | | | | | adjustment |
| | First | | ITO[nm] | | layer/ |
| | layer[nm] | SiO2[nm] | Trans- | SiO2[nm] | Trans- |
| | Color tone | Color tone | parent | Reflection | parent |
| | correction | correction | conductive | adjustment | conductive |
| | layer | layer | layer | layer | layer |
| Example 1 | 12 | 35 | 100 | 80 | 0.80 |
| Example 2 | 12 | 35 | 160 | 70 | 0.44 |
| Example 3 | 12 | 18 | 100 | 70 | 0.70 |
| Example 4 | 12 | 18 | 100 | 60 | 0.60 |
| Example 5 | 14 | 35 | 120 | 60 | 0.50 |
| Example 6 | 10 | 35 | 140 | 70 | 0.50 |
| Example 7 | 10 | 35 | 150 | 80 | 0.53 |
| Example 8 | 12 | 18 | 100 | 60 | 0.60 |
| Example 9 | 14 | 35 | 120 | 60 | 0.50 |
| Example 10 | 10 | 35 | 140 | 70 | 0.50 |
| Example 11 | 10 | 35 | 150 | 80 | 0.53 |
| Example 12 | 12 | 18 | 100 | 60 | 0.60 |
| Example 13 | 14 | 35 | 120 | 60 | 0.50 |
| Example 14 | 10 | 35 | 140 | 70 | 0.50 |
| Example 15 | 10 | 35 | 150 | 80 | 0.53 |
| Example 16 | 12 | 18 | 100 | 60 | 0.60 |
| Example 17 | 14 | 35 | 120 | 60 | 0.50 |
| Example 18 | 10 | 35 | 140 | 70 | 0.50 |
| Example 19 | 10 | 35 | 150 | 80 | 0.53 |
| Example 20 | 10 | 35 | 145 | 70 | 0.48 |
| Example 21 | 10 | 35 | 145 | 70 | 0.48 |
| Example 22 | 10 | 35 | 140 | 70 | 0.50 |
| Example 23 | 10 | 35 | 140 | 70 | 0.50 |
| Example 24 | 20 | 0 | 140 | 57 | 0.41 |
| Example 25 | 10 | 35 | 140 | 70 | 0.50 |
| Example 26 | 10 | 35 | 140 | 70 | 0.50 |
| Example 27 | 8 | 38 | 140 | 70 | 0.50 |
| Example 28 | 12 | 43 | 140 | 70 | 0.50 |

Measurements and sensitivity tests were performed in order to evaluate the samples prepared as described above.

### <Measurements>

The total light transmittance when the PDLC-type light control film was turned off was measured by a measurement method in conformity with JIS K7136. A haze meter HZ-V3 was used to measure the total light transmittance. The visible light reflectance of the surface of the laminated glass on the side of the low-emissivity film was measured by a measurement method in conformity with JIS R3106. A spectrophotometer U-4100 (manufactured by Hitachi High-Tech Corporation) was used to measure the visible light reflectance. The haze value when the PDLC-type light control film was turned off was measured by a measurement method in conformity with JIS K7136. The emissivity of the surface of the laminated glass on the side of the low-emissivity film was measured by a measurement method in conformity with JIS R1801. Fourier transform infrared spectrophotometer IRPrestige-21 (manufactured by Shimadzu Corporation) was used to measure the emissivity. The haze meter HZ-V3 (manufactured by Suga Test Instruments Co., Ltd.) was used to measure the haze value.

### <Sensitivity Test>

Regarding the haze discomfort when the PDLC-type light control film was turned off and the laminated glass was viewed from the indoor side, the sensitivity was evaluated and classified into one of the following five stages.
1: No discomfort (grainy appearance cannot be recognized)
2: No discomfort (grainy appearance can be recognized)
3: No discomfort (grainy appearance can be recognized clearly)
4: No discomfort but a sense of incongruity
5: Feeling discomfort

Regarding the reflection of the interior of the cabin on the laminated glass when the PDLC-type light control film was turned off and the laminated glass was viewed from the indoor side, the sensitivity was evaluated and classified into one of the following five stages.
1: Cannot visually recognized
2: Can visually recognize that something is present
3: Interior of the cabin can be visually recognized when paying careful attention
4: Interior of the cabin can be visually recognized normally
5: Interior of the cabin can be visually recognized clearly

Regarding the degree of dazzling when the PDLC-type light control film was turned off and the laminated glass was viewed from the indoor side to the outdoor side, the sensitivity was evaluated and classified into one of the following three stages.
1: No dazzling when looking directly at the sun
2: Dazzling when looking directly at the sun; but an acceptable degree of dazzling
3: Cannot look directly at the sun; that is, an unacceptable degree of dazzling

The results of the measurement and the sensitivity tests of the samples according to Examples 1 to 28 are shown in Table 3 below.

TABLE 3

| | Total light | Visible light | Haze | | Haze | | Degree of |
|---|---|---|---|---|---|---|---|
| | transmittance[%] | reflectance[%] | value[%] | Emissivity | discomfort[—] | Reflection[—] | dazzling[—] |
| Example 1 | 0.01 | 0.15 | 98 | 0.24 | 5 | 3 | 1 |
| Example 2 | 0.01 | 4.0 | 98 | 0.13 | 2 | 5 | 1 |
| Example 3 | 14 | 0.23 | 98 | 0.24 | 5 | 2 | 3 |
| Example 4 | 0.02 | 0.29 | 98 | 0.24 | 4 | 2 | 1 |
| Example 5 | 0.02 | 0.95 | 98 | 0.20 | 4 | 3 | 1 |
| Example 6 | 0.02 | 2.1 | 98 | 0.17 | 3 | 4 | 1 |
| Example 7 | 0.02 | 3.2 | 98 | 0.15 | 2 | 4 | 1 |
| Example 8 | 0.12 | 0.29 | 98 | 0.24 | 4 | 2 | 1 |
| Example 9 | 0.12 | 0.95 | 98 | 0.20 | 3 | 2 | 1 |
| Example 10 | 0.12 | 2.1 | 98 | 0.17 | 3 | 3 | 1 |
| Example 11 | 0.12 | 3.2 | 98 | 0.15 | 2 | 4 | 1 |
| Example 12 | 0.77 | 0.29 | 98 | 0.24 | 3 | 1 | 1 |
| Example 13 | 0.77 | 0.95 | 98 | 0.2 | 3 | 2 | 1 |
| Example 14 | 0.77 | 2.1 | 98 | 0.17 | 2 | 3 | 1 |
| Example 15 | 0.77 | 3.2 | 98 | 0.15 | 2 | 4 | 1 |
| Example 16 | 5.8 | 0.29 | 98 | 0.24 | 3 | 1 | 2 |
| Example 17 | 5.8 | 0.95 | 98 | 0.20 | 3 | 2 | 2 |
| Example 18 | 5.8 | 2.1 | 98 | 0.17 | 2 | 3 | 2 |
| Example 19 | 5.8 | 3.2 | 98 | 0.15 | 2 | 4 | 2 |
| Example 20 | 0.77 | 3.5 | 98 | 0.16 | 2 | 4 | 1 |
| Example 21 | 5.8 | 3.5 | 98 | 0.16 | 2 | 4 | 2 |
| Example 22 | 0.02 | 3.2 | 98 | 0.17 | 2 | 4 | 1 |
| Example 23 | 0.72 | 3.2 | 98 | 0.17 | 2 | 4 | 1 |
| Example 24 | 0.76 | 2.3 | 98 | 0.17 | 2 | 3 | 1 |
| Example 25 | 0.02 | 2.4 | 98 | 0.17 | 3 | 4 | 1 |
| Example 26 | 0.75 | 2.4 | 98 | 0.17 | 2 | 3 | 1 |
| Example 27 | 0.77 | 2.1 | 98 | 0.17 | 2 | 3 | 1 |
| Example 28 | 0.77 | 2.1 | 98 | 0.17 | 2 | 3 | 1 |

The visible light reflectance of the laminated glass varies depending on the combination of the film thicknesses of the first layer of the color tone correction layer, the second layer of the color tone correction layer, the transparent conductive layer, and the reflection adjustment layer. The total light transmittance of the laminated glass when the PDLC-type light control film was turned off varies depending on the material constituting the glass plate and the intermediate film. As shown in Table 3, in the samples according to Examples 4 to 28, when the PDLC-type light control film was turned off, the total light transmittance of the laminated glass was 5.8% or less, the visible light reflectance was 0.2% or more and 3.5% or less, and the haze value was 50% or more. In the samples according to Examples 4 to 28, the haze discomfort score was 4 or less, which was good. In the samples according to Examples 4 to 28, the reflection score was 4 or less, which was good. In the samples according to Examples 4 to 28, the dazzling score was 2 or less, which was good.

By the comparison among the samples according to Examples 1 to 4, it was found that haze discomfort can be reduced in a case where, when the PDLC-type light control film is turned off, the total light transmittance of the laminated glass is 5.8% or less and the visible light reflectance is 0.2% or more. In a case where the visible light reflectance is 0.2% or less, that is, in a case where the visible light reflectance is too low, the influence of the reflected light is small when the surface on the side of the low-emissivity film 16 is viewed from the inside of a vehicle or a cabin, and a grainy appearance generated in the PDLC-type light control film based on its principle can be visually recognized as it is, so that haze discomfort is likely to be generated. In a case where the visible light reflectance is 0.2% or more, that is, in a case where an appropriate amount of reflected light is present, a grainy appearance of the PDLC-type light control film can be appropriately shielded, so that haze discomfort can be reduced. By the comparison among the samples and the like according to Examples 16 to 19 and 21, it was confirmed that the reflection can be further reduced when the visible light reflectance is reduced. By the comparison among the samples and the like according to Examples 3 and 16, it was confirmed that the degree of dazzling can be further reduced when the total light transmittance of the laminated glass when the PDLC-type light control film is turned off is reduced.

Although the present invention has been described above with reference to the above embodiments, the present invention is not limited only to the configurations of the above-described embodiments. Needless to say, the present invention includes various modifications, changes, and combinations that can be made by a person skilled in the art within the scope of the claimed invention of the present application.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A laminated glass comprising a first glass plate, a first intermediate film, a PDLC-type light control film, a second intermediate film, and a second glass plate in this order, wherein
the laminated glass has a total light transmittance of 10% or less and a haze value of 50% or more when the PDLC-type light control film is turned off,
the second glass plate includes a low-emissivity film on a surface thereof opposite to a side of the second intermediate film, and
a visible light reflectance of a surface of the low-emissivity film opposite to a side of the second glass plate is 0.2% or more and 3.8% or less.

2. The laminated glass according to claim 1, wherein
the low-emissivity film includes a transparent conductive layer and a reflection adjustment layer in this order from the side of the second glass plate, and
a ratio of a film thickness of the reflection adjustment layer to a film thickness of the transparent conductive layer is 0.47 or more and 0.70 or less.

3. A laminated glass comprising a first glass plate, a first intermediate film, a PDLC-type light control film, a second intermediate film, and a second glass plate in this order, wherein
the laminated glass has a total light transmittance of 10% or less and a haze value of 50% or more when the PDLC-type light control film is turned off,
the second glass plate includes a low-emissivity film on a surface thereof opposite to a side of the second intermediate film,
the low-emissivity film includes a transparent conductive layer and a reflection adjustment layer in this order from the side of the second glass plate, and
a ratio of a film thickness of the reflection adjustment layer to a film thickness of the transparent conductive layer is 0.47 or more and 0.70 or less.

4. The laminated glass according to claim 3, wherein a visible light reflectance of a surface of the low-emissivity film opposite to the side of the second glass plate is 0.2% or more and 3.8% or less.

5. The laminated glass according to claim 2, wherein a film thickness of the transparent conductive layer is 80 nm or more and 160 nm or less.

6. The laminated glass according to claim 2, wherein a film thickness of the reflection adjustment layer is 50 nm or more and 100 nm or less.

7. The laminated glass according to claim 2, wherein the transparent conductive layer is an ITO layer, a tin oxide layer, a fluorine-doped tin oxide layer, an antimony-doped tin oxide layer, a silver layer, a zirconium nitride layer, or a titanium nitride layer.

8. The laminated glass according to claim 2, wherein the reflection adjustment layer includes an oxide or an oxynitride of at least one metal selected from a group consisting of Ti, Nb, Ta, Zn, Al, In, Si, and Zr.

9. The laminated glass according to claim 2, wherein
the low-emissivity film further includes a color tone correction layer,
the color tone correction layer includes a plurality of layers including a first layer and a second layer in this order from the side of the second glass plate, and
a refractive index of the first layer for light having a wavelength of 630 nm is higher than a refractive index of the second layer for light having a wavelength of 630 nm.

10. The laminated glass according to claim 9, wherein
the refractive index of the first layer for light having a wavelength of 630 nm is 1.7 or more and 2.5 or less, and
the refractive index of the second layer for light having a wavelength of 630 nm is 1.6 or less.

11. The laminated glass according to claim 2, wherein
the low-emissivity film further includes a color tone correction layer, and
the color tone correction layer includes an oxide or an oxynitride of at least one metal selected from a group consisting of Ti, Nb, Ta, Zn, Al, In, Si, and Zr.

12. The laminated glass according to claim 2, wherein
the low-emissivity film includes a color tone correction layer between a surface of the second glass plate on a side of the low-emissivity film and the transparent conductive layer, and
a film thickness of the color tone correction layer is 20 nm or more and 60 nm or less.

13. The laminated glass according to claim 1, wherein an emissivity of the surface of the low-emissivity film opposite to the side of the second glass plate is 0.3 or less.

14. The laminated glass according to claim 2, wherein the low-emissivity film includes an adhesion improvement layer disposed between the transparent conductive layer and the reflection adjustment layer.

15. A laminated glass for a vehicle, the laminated glass comprising the laminated glass according to claim 1.
